(19) United States
(12) Patent Application Publication
(10) Pub. No.: US 2026/0017737 A1
(43) Pub. Date: Jan. 15, 2026

(54) PREDICTION AND PREVENTION OF CYBERSQUATTING EVENTS

(71) Applicant: International Business Machines Corporation, Armonk, NY (US)

(72) Inventors: Uri Kartoun, Cambridge, MA (US); Sophie Batchelder, Cambridge, MA (US); Derek Leist, Boston, MA (US); Jeremy R. Fox, Georgetown, TX (US)

(21) Appl. No.: 18/768,017

(22) Filed: Jul. 10, 2024

(51) Int. Cl. G06Q 50/18

(52) U.S. Cl. CPC G06Q 50/184

(57) ABSTRACT

Prediction and prevention of cybersquatting events include receiving a first input by a computer associated with a first trademark term. A first set of features associated with the first trademark term is determined based on the received first input. Based on application of a first machine learning (ML) model on the determined first set of features, the first confidence score is predicted. The first confidence score is indicative of at least one cybersquatting event associated with the first trademark term. A first alert is rendered based on the predicted first confidence score.

### BACKGROUND

The disclosure relates to cybersquatting and more particularly, to prediction and prevention of cybersquatting events.

The proliferation of the Internet and the expansion of e-commerce have led to an increased reliance on domain names as critical business assets. Domain names serve as an online identifier for businesses and are integral to brand recognition and consumer trust. As businesses invest heavily in building their brand identities online, the protection of these digital assets becomes paramount. However, this growth has also seen a rise in cybersquatting, a practice where individuals (also called cybersquatters) register domain names identical or confusingly similar to trademarked terms with malicious intent or for profit. The cybersquatters aim to exploit the trademark owner's established brand equity, often intending to sell the domain back to the trademark owner at an inflated price, divert web traffic to unrelated or malicious websites, or damage the brand's reputation. This practice poses significant challenges for trademark owners, leading to consumer confusion, lost revenue, and potential harm to the brand's image.

Despite legal frameworks such as the Anti-Cybersquatting Consumer Protection Act (ACPA) in the United States and the Uniform Domain-Name Dispute-Resolution Policy (UDRP) administered by the Internet Corporation for Assigned Names and Numbers (ICANN), the detection of cybersquatting remains a challenge. Traditional methods rely heavily on manual monitoring and reporting, which are not only labor-intensive but also prone to human error and delay.

### SUMMARY

According to an embodiment of the disclosure, a computer-implemented method for prediction and prevention of cybersquatting events is described. The computer-implemented method includes receiving, by a computer, a first input associated with a first trademark term. The computer-implemented method further includes determining, by the computer, a first set of features associated with the first trademark term based on the received first input. The computer-implemented method further includes predicting, by the computer, a first confidence score indicative of at least one cybersquatting event associated with the first trademark term based on application of a first machine learning (ML) model on the determined first set of features. The computer-implemented method further includes rendering, by the computer, a first alert based on the predicted first confidence score.

According to one or more embodiments of the disclosure, a system for prediction and prevention of cybersquatting events is described. The system performs a method for prediction and prevention of cybersquatting events. The method includes receiving, from a first set of databases, first registration information associated with a registration of a first trademark term. The method further includes determining one or more domain names associated with the first trademark term based on the received first registration information. The method further includes predicting, by a first machine learning (ML) model, a first confidence score indicative of at least one cybersquatting event associated with the first trademark term based on the determined one or more domain names. The first ML model is pre-trained on a training dataset stored in a second set of databases associated with a set of cybersquatting events. The method further includes rendering a first alert based on the first confidence score.

According to one or more embodiments of the disclosure, a computer program product for prediction of at least one cybersquatting event associated with a first trademark term is described. The computer program product includes a computer-readable storage medium having program instructions embodied therewith, the program instructions executable by a system to cause the system to receive a first input associated with the first trademark term from a first electronic device. The first trademark term is registered by a first entity. The program instructions further include determining a first set of features associated with the first trademark term based on the received first input. The program instructions further include predicting a first confidence score indicative of at least one cybersquatting event associated with the first trademark term based on application of a first machine learning (ML) model on the determined first set of features. The first ML model is trained on a training dataset including a set of historical trademark terms and one or more cybersquatting events associated with each historical trademark term of the set of historical trademark terms. The program instructions further include rendering a first alert on the first electronic device associated with the first entity.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for prediction and prevention of cybersquatting events, in accordance with an embodiment of the disclosure;

FIG. 2 is a diagram that illustrates an environment for prediction of cybersquatting events, in accordance with an embodiment of the disclosure;

FIG. 3 is a diagram that illustrates exemplary operations for prediction of cybersquatting events, in accordance with an embodiment of the disclosure;

FIG. 4 is a diagram that illustrates exemplary operations for prevention of cybersquatting events, in accordance with an embodiment of the disclosure;

FIG. 5 is a diagram depicting training of the first ML model for the prediction of confidence score associated with a possibility of a cybersquatting event, according to one embodiment;

FIG. 6 is a diagram that illustrates an exemplary timeline for prevention of an exemplary cybersquatting event, in accordance with an embodiment of the disclosure;

FIG. 7A is diagram that depicts exemplary registration page for monitoring a trademark term, in accordance with an embodiment of the disclosure;

FIG. 7B is diagram that depicts exemplary analysis page associated with a possibility of the cybersquatting event associated with the trademark term, in accordance with an embodiment of the disclosure;

FIG. 7C is diagram that depicts exemplary alert after the detection of a cybersquatting event associated with the trademark term, in accordance with an embodiment of the disclosure;

FIG. 7D is diagram that depicts exemplary conformation message after the transmission of the legal notice to the one or more electronic devices, in accordance with an embodiment of the disclosure;

FIG. 8 is a flowchart that illustrates an exemplary method for prediction of cybersquatting events, in accordance with an embodiment of the disclosure; and

FIG. 9 is a flowchart that illustrates an exemplary method for prevention of cybersquatting events, in accordance with an embodiment of the disclosure.

### DETAILED DESCRIPTION

The proliferation of the Internet and the expansion of online commerce have led to significant challenges in protecting intellectual property rights, particularly trademark rights. One such challenge is cybersquatting, a practice where individuals or entities register, sell, or use a domain name containing a trademarked term (or similar to the trademark term) with an intent to profit from the goodwill of the trademark belonging to someone else. Usually, cybersquatting misleads the consumers, dilutes brand value, and causes substantial harm to the reputation and financial interests of trademark owners.

Trademark owners face difficulties in monitoring the vast number of domain registrations and identifying potential cybersquatting incidents. Traditional methods of detection typically involve manual searches and ad hoc reporting, which are cumbersome, time-consuming and often reactive rather than proactive. This lag in response usually results in significant damage before any remedial action is taken.

Various legal frameworks, such as the Anti cybersquatting Consumer Protection Act (ACPA) in the United States, provide mechanisms for trademark owners to challenge cybersquatting. However, the legal process can be lengthy and costly. Usually, cease-and-desist notices are a common first step in addressing cybersquatting, but their effectiveness depends on timely identification of the infringement and prompt action.

To address these issues, there is a need for an automated system that can predict the likelihood of cybersquatting events associated with trademarked terms, detect actual cybersquatting incidents, inform trademark owners in a timely manner, and facilitate the issuance of the cease-and-desist notices to the cybersquatters. Such a system may leverage machine learning models, natural language processing, and real-time monitoring to provide a comprehensive solution for trademark protection in the digital age.

Existing solutions in the market for combating cybersquatting are often fragmented and lack the integration required for efficient trademark protection. These solutions typically fall into one of several categories such as domain monitoring services, legal consultation, or software tools for sending automated legal notices. However, these services and tools often operate in silos, requiring trademark owners to manually correlate information and take multiple steps to address a single incident of cybersquatting.

The proposed system aims to fill this gap by providing an integrated platform that not only identifies and predicts potential cybersquatting activities but also streamlines the process of notifying trademark owners and taking appropriate legal action. The system is designed to operate continuously, scanning domain registrations and related internet activities in real-time to detect any signs of cybersquatting.

The core components of the disclosed system utilize machine learning algorithms, to analyze trends in domain registrations and other relevant data to predict the likelihood of a cybersquatting event before it occurs. By identifying patterns and anomalies associated with cybersquatting activities, the system may be capable of alerting trademark owners to potential threats early. Moreover, the disclosed system continuously monitors domain name registrations where trademarked terms or terms similar to the trademarked terms that have been registered or are being used without authorization. Upon detection of a potential or an actual cybersquatting event, the disclosed system automatically informs the trademark owner through preferred communication channels such as email, a message, or a dedicated dashboard. This timely notification allows trademark owners to quickly assess the situation and decide on the next steps. Furthermore, the system may be capable of generating and issuing legally compliant cease-and-desist notices to identified cybersquatters. By integrating legal templates and jurisdiction-specific requirements, this feature ensures that the notices are both effective and legally enforceable. Also, the disclosed system provides a comprehensive dashboard that provides trademark owners with detailed reports on detected cybersquatting activities, predictive analytics insights, and the status of issued cease-and-desist notices. This centralized view helps in managing and mitigating risks associated with cybersquatting.

This integrated approach not only enhances the ability of trademark owners to safeguard their intellectual property more effectively and efficiently but also significantly reduces the resources required to combat cybersquatting. By automating the prediction, detection, notification, and enforcement processes, the proposed system provides a robust defense mechanism against the evolving threat of cybersquatting in the digital age.

According to an embodiment of the disclosure, a computer-implemented method for prediction and prevention of cybersquatting events is described. The computer-implemented method includes receiving, by a computer, a first input associated with a first trademark term. The computer-implemented method further includes determining, by the computer, a first set of features associated with the first trademark term based on the received first input. The computer-implemented method further includes predicting, by the computer, a first confidence score indicative of at least one cybersquatting event associated with the first trademark term based on application of a first machine learning (ML) model on the determined first set of features. The computer-implemented method further includes rendering, by the computer, a first alert based on the predicted first confidence score.

In other embodiments of the disclosure, the first trademark term is associated with a first entity. The at least one cybersquatting event corresponds to a registration of one or more domain names associated with the first trademark term by a second entity different from the first entity.

In other embodiments of the disclosure, the computer-implemented method further includes retrieving, by the computer, first registration information associated with a registration of the first trademark term by the first entity. The first registration information is retrieved from a first set of databases. The computer-implemented method further includes retrieving, by the computer, second registration information associated with the registration of the one or more domain names by the second entity. The computer-implemented method further includes rendering, by the computer, a second alert based on a comparison of the retrieved first registration information with the retrieved second registration information.

In other embodiments of the disclosure, the computer-implemented method further includes receiving, by the computer, a second input associated with a transmission of a legal notice to one or more electronic devices. The second input is received based on the rendered second alert. The computer-implemented method further includes transmitting, by the computer, the legal notice to the one or more electronic devices based on the received second input. The legal notice corresponds to a cease-and-desist notice.

In other embodiments of the disclosure, the computer-implemented method further includes generating, by the computer, the legal notice based on application of a second machine learning (ML) model on the retrieved first registration information, the retrieved second registration information, and the received second input. The computer-implemented method further includes transmitting, by the computer, the generated legal notice to the one or more electronic devices.

In other embodiments of the disclosure, the computer-implemented method further includes generating, by the computer, a second set of databases with a set of cybersquatting events based on at least one of the first trademark term, the first set of features, the first registration information, the second registration information, and the first confidence score. The second registration information is retrieved from a third set of databases. The computer-implemented method further includes predicting, by the computer, a second confidence score associated with at least one cybersquatting event associated with a second trademark term based on the generated second set of databases.

In other embodiments of the disclosure, the first set of features includes at least one of a length of the first trademark term, or classification information associated with the first trademark term. In other embodiments additional features may be considered such as a sequence of characters, e.g., “ab”, “ac”, “ad”, etc. A feature may be the type, quantity, and location (index) of one or more characters, e.g., a letter, a number, or a mark (e.g., “!”, “,”, “@”, “-”). For a trademark term, for example, “abcddd”, a series of features would be a1, b2, c3, d4, d5, d6, indicating index locations of each character. In another example, the series of features may also be a1, b, c1, and d3, indicating quantity of each character. In another example, a feature may correspond to the total number of words. In another embodiment, a feature selection method may be applied to rank and identify a subset of most informative features. Such a method may be, for example, a sub-population-based feature selection (https://www.rle.mit.edu/cb/sub-population-based-feature-selection-sbpfs/) or a Least Absolute Shrinkage and Selection Operator (LASSO).

In other embodiments of the disclosure, the computer-implemented method further includes determining, by the computer, one or more domain names associated with the first trademark term based on application of natural language processing on the first trademark term. The computer-implemented method further includes predicting, by the computer, the first confidence score indicative of the at least one cybersquatting event associated with the first trademark term based on the determined one or more domain names. The at least one cybersquatting event corresponds to a registration of the one or more domain names.

In other embodiments of the disclosure, the computer-implemented method further includes generating, by the computer, a training dataset including historical trademark term data associated with a set of historical trademark terms and historical event data associated with one or more cybersquatting events associated with each historical trademark term of the set of historical trademark terms. The computer-implemented method further includes training, by the computer, the first ML model based on the generated training dataset.

In other embodiments of the disclosure, the computer-implemented method further includes calculating, by the computer, a first interval associated with registration of one or more domain names based on a first timestamp associated with the registration of the first trademark term and a second timestamp associated with the at least one cybersquatting event. The computer-implemented method further includes training, by the computer, the first ML model based on the calculated first interval. A second confidence score associated with at least one cybersquatting event associated with a second trademark term is predicted based on the calculated first interval.

According to one or more embodiments of the disclosure, a system for prediction and prevention of cybersquatting events is described. The system performs a method for prediction and prevention of cybersquatting events. The method includes receiving, from a first set of databases, first registration information associated with a registration of a first trademark term. The method further includes determining one or more domain names associated with the first trademark term based on the received first registration information. The method further includes predicting, by a first machine learning (ML) model, a first confidence score indicative of at least one cybersquatting event associated with the first trademark term based on the determined one or more domain names. The first ML model is pre-trained on a training dataset stored in a second set of databases associated with a set of cybersquatting events. The method further includes rendering a first alert based on the first confidence score.

In other embodiments of the disclosure, the training dataset includes historical trademark term data associated with a set of historical trademark terms and historical event data associated with one or more cybersquatting events associated with each historical trademark term of the set of historical trademark terms.

In other embodiments of the disclosure, the first trademark term is associated with a first entity. The at least one cybersquatting event corresponds to a registration of the one or more domain names associated with the first trademark term by a second entity different from the first entity.

In other embodiments of the disclosure, the system further includes monitoring a third set of databases for a first event associated with the registration of the one or more domain names. The third set of databases is associated with one or more domain name registrars. The system further includes retrieving second registration information associated with the registration of the one or more domain names based on a detection of the first event. The system further includes rendering a second alert based on a comparison of the received first registration information and the retrieved second registration information. The second alert is indicative of registration of the one or more domain names by the second entity.

In other embodiments of the disclosure, the system includes receiving an input associated with a transmission of a legal notice to one or more electronic devices based on the rendered second alert. The system further includes transmitting the legal notice to the one or more electronic devices based on the received input. The legal notice corresponds to a cease-and-desist notice.

In other embodiments of the disclosure, the system includes generating the legal notice based on application of a second machine learning (ML) model on the received first registration information, the retrieved second registration information, and the received input. The system further includes transmitting the generated legal notice to the one or more electronic devices.

In other embodiments of the disclosure, the system includes determining a first set of features associated with the first trademark term based on the received first registration information. The system further includes training the first ML model based on the determined first set of features, the received first registration information, and the retrieved second registration information.

In other embodiments of the disclosure, the first set of features includes at least one of a length of the first trademark term, or classification information associated with the first trademark term.

In other embodiments of the disclosure, the system includes calculating a first interval associated with registration of the one or more domain names based on a first timestamp associated with a registration of the first trademark term and a second timestamp associated with the at least one cybersquatting event. The system further includes training the first ML model based on the calculated first interval.

According to one or more embodiments of the disclosure, a computer program product for prediction of at least one cybersquatting event associated with a first trademark term is described. The computer program product includes a computer-readable storage medium having program instructions embodied therewith, the program instructions executable by a system to cause the system to receive a first input associated with the first trademark term from a first electronic device. The first trademark term is registered by a first entity. The program instructions further include determining a first set of features associated with the first trademark term based on the received first input. The program instructions further include predicting a first confidence score indicative of at least one cybersquatting event associated with the first trademark term based on application of a first machine learning (ML) model on the determined first set of features. The first model is trained on a training dataset including historical trademark term data associated with a set of historical trademark terms and historical event data associated with one or more cybersquatting events associated with each historical trademark term of the set of historical trademark terms. The program instructions further include rendering a first alert on the first electronic device associated with the first entity.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

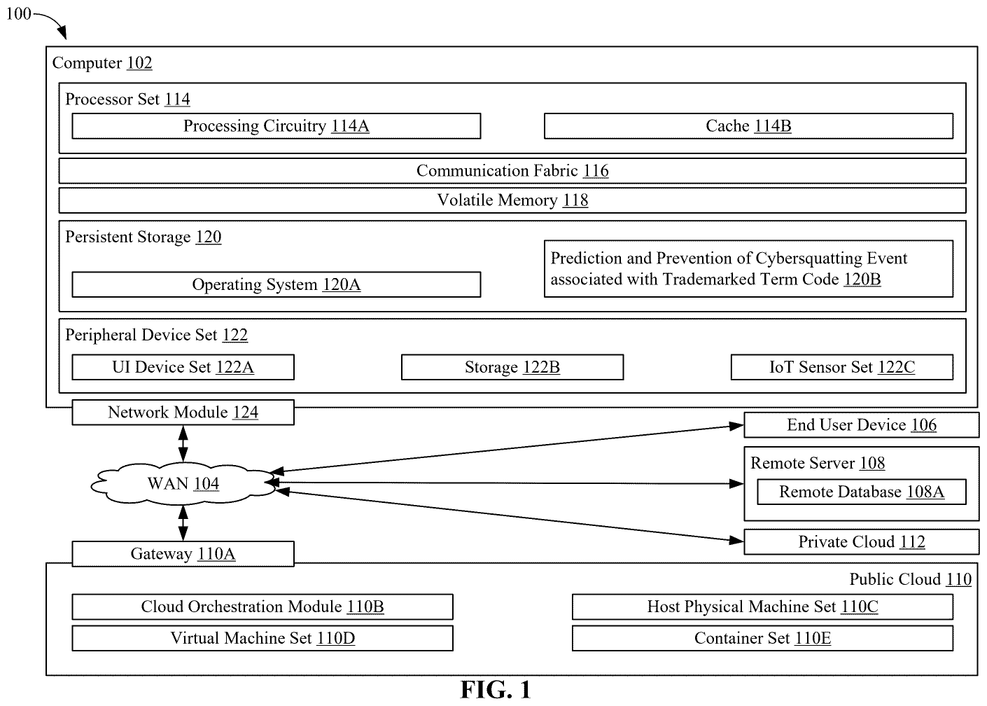

FIG. 1 is a diagram that illustrates a computing environment for prediction and prevention of cybersquatting events, in accordance with an embodiment of the disclosure. With reference to FIG. 1, there is shown a computing environment 100 that contains an example of an environment for the execution of at least some of the computer code involved in performing the inventive methods, such as a prediction and prevention of cybersquatting event associated with trademarked term code 120B. In addition to the prediction and prevention of cybersquatting event associated with trademarked term code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the prediction and prevention of cybersquatting event associated with trademarked term code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 114B and the other storage media discussed below. The program instructions, and associated data, are accessed by the processor set 114 to control and direct the performance of the inventive methods. In computing environment 100, at least some of the instructions for performing the inventive methods may be stored in the dynamic modification of the prediction and prevention of cybersquatting event associated with trademarked term code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the prediction and prevention of cybersquatting event associated with trademarked term code 120B typically includes at least some of the computer code involved in performing the inventive methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In other embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in other embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

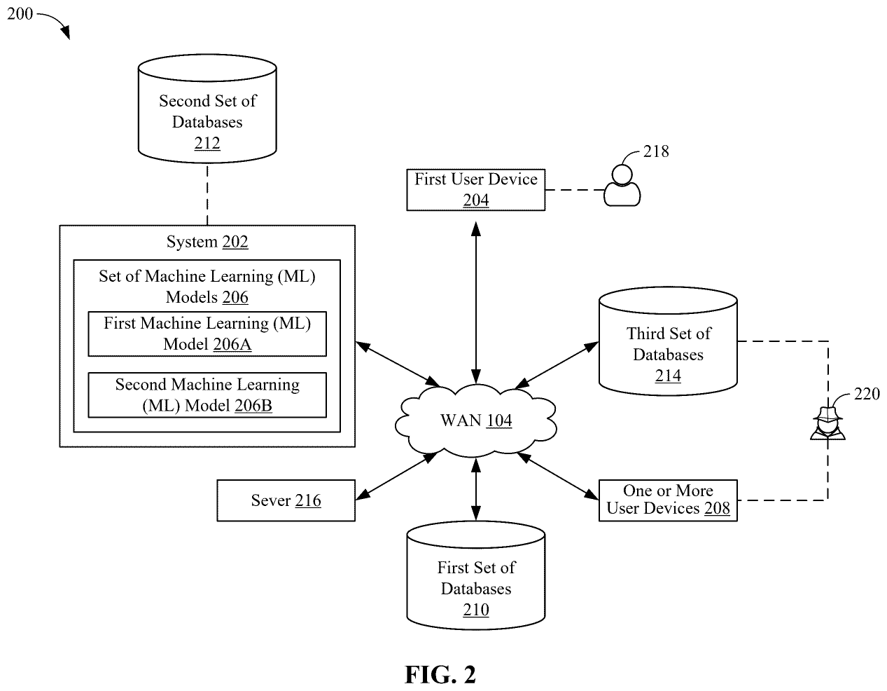

FIG. 2 is a diagram that illustrates an environment for prediction of cybersquatting events, in accordance with an embodiment of the disclosure. FIG. 2 is explained in conjunction with elements from FIG. 1. With reference to FIG. 2, there is shown a diagram of a network environment 200. The network environment 200 includes a system 202, a first user device 204, a set of machine learning (ML) models 206, and one or more electronic devices 208. There is further shown a first set of databases 210, a second set of databases 212, a third set of databases 214, and a server 216. The network environment 200 further includes a first entity 218 associated with the first user device 204 and a second entity 220 associated with the one or more electronic devices 208. The network environment 200 further includes the WAN 104 of FIG. 1. In an embodiment of the disclosure, the first user device 204 and the one or more electronic devices 208 may be an exemplary embodiment of the EUD 106. Similarly, the system 202 may be an exemplary embodiment of the computer 102 in FIG. 1.

The system 202 may include suitable logic, circuitry, interfaces, and/or code that may be configured for prediction of cybersquatting events associated with trademarked terms. The system 202 may be configured to receive a first input associated with a first trademarked term. The system 202 may be configured to determine a first set of features associated with the first trademarked term. The system 202 may be further configured to provide the first set of features associated with the first trademarked term, as an input, to a first machine learning (ML) model 206A of the set of ML models 206. The system 202 may be further configured to receive a first confidence score indicative of a cybersquatting event associated with the first trademarked term, as an output, of the first ML model 206A. The system 202 may be further configured to render a first alert based on the received first confidence score. Examples of the system 202 may include, but are not limited to, a server, a computing device, a virtual computing device, a mainframe machine, a computer workstation, a smartphone, a cellular phone, a mobile phone, a gaming device, or a consumer electronic (CE) device.

The first user device 204 may include suitable logic, circuitry, interfaces, and/or code that may be configured to receive the first input from the first entity 218 and transmit the received first input to the system 202. In an embodiment, the first user device 204 may be further configured to render the first alert received from the system 202 on a display screen associated with the first user device 204. In an embodiment, the first user device 204 may include a display screen. In an embodiment, the first entity 218 may correspond to a stand-alone user or an organization. Examples of the first user device 204 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other device with computer vision display capabilities.

The display screen may include suitable logic, circuitry, and interfaces that may be configured to render the generated first alert. In some embodiments of the disclosure, the display screen may be an external display device associated with the first user device 204. The display screen may be a touch screen which may enable the first entity 218 to provide the first input via the display screen. The touch screen may be at least one of a resistive touch screen, a capacitive touch screen, or a thermal touch screen. In accordance with an embodiment of the disclosure, the display screen may refer to a display screen of a head-mounted device (HMD), a smart-glass device, a see-through display, a projection-based display, an electro-chromic display, or a transparent display. In some embodiments of the disclosure, the display screen may be realized through several known technologies such as, but are not limited to, at least one of a Liquid Crystal Display (LCD) display, a Light Emitting Diode (LED) display, a plasma display, or an Organic LED (OLED) display technology, or other display devices.

The first ML model 206A of the set of ML models 206 may be a computational network or a system of artificial neurons, arranged in a plurality of layers, as nodes. The plurality of layers of the first ML model 206A may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the first ML model 206A. Outputs of each hidden layer may be coupled to inputs of at least one node in other layers of the first ML model 206A. Node(s) in the final layer may receive inputs from at least one hidden layer to output a result. The number of layers and the number of nodes in each layer may be determined from hyper-parameters of the first ML model 206A. Such hyper-parameters may be set before or while training the first ML model 206A on a training dataset.

Each node of the first ML model 206A may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the first ML model 206A. All or some of the nodes of the first ML model 206A may correspond to the same or a different mathematical function.

In training of the first ML model 206A, one or more parameters of each node of the first ML model 206A may be updated based on whether an output of the final layer for a given input (from the training dataset) matches a correct result based on a loss function for the first ML model 206A. The above process may be repeated for the same or a different input until a minima of loss function may be achieved, and a training error may be minimized. Several methods for training are known in art, for example, gradient descent, stochastic gradient descent, batch gradient descent, gradient boost, meta-heuristics, and the like.

The first ML model 206A may include electronic data, such as, for example, a software program, code of the software program, libraries, applications, scripts, or other logic or instructions for execution by a processing device, such as processor set. The first ML model 206A may include code and routines configured to enable a computing device, such as the system 202 to perform one or more operations. Additionally, or alternatively, the first ML model 206A may be implemented using hardware including a processor, a microprocessor (e.g., to perform or control performance of one or more operations), a field-programmable gate array (FPGA), or an application-specific integrated circuit (ASIC). Alternatively, in some embodiments, the first ML model 206A may be implemented using a combination of hardware and software. Although in FIG. 2, the first ML model 206A is shown as a separate entity from the system 202, the disclosure is not so limited. Accordingly, in some embodiments, the first ML model 206A may be integrated within the system 202, without deviation from scope of the disclosure. In an embodiment, the first ML model 206A may be stored in the server 216. Examples of the first ML model 206A may include, but are not limited to, a deep neural network (DNN), a convolutional neural network (CNN), a CNN-recurrent neural network (CNN-RNN), an artificial neural network (ANN), a fully connected neural network, and/or a combination of such networks.

The second ML model 206B of the set of ML models 206 may correspond to a computer-based system or software that exhibits characteristics commonly associated with human intelligence. The second ML model 206B may be designed to perform tasks that typically require human intelligence, such as problem-solving, learning, reasoning, perception, understanding natural language, and decision-making. AI systems can range from simple rule-based programs to sophisticated, self-learning systems.

The second ML model 206B may be a sophisticated piece of software that leverages natural language processing (NLP) and machine learning techniques to understand, generate, and manipulate human language. For example, the second ML model 206B may correspond to a language model or a large language model (LLM) model that is specifically designed for tasks related to language understanding and generation on a large scale. Certain characteristics of the LLM model may include, but are not limited to, natural language understanding, text generation, semantic understanding, transfer learning, multimodal capabilities, continuous learning, and user interaction. In an example, the LLM model for language processing may be implemented using GPT, Bidirectional Encoder Representations from Transformers (BERT), and the like.

Further, the LLM may be a type of ML model specifically designed to understand, generate, and manipulate human language on a large scale. LLMs may leverage machine learning techniques, particularly those based on deep learning architectures, to process and comprehend natural language. LLMs have gained prominence for their ability to perform a wide range of language-related tasks, including natural language understanding, text generation, translation, summarization, and more. Typically, LLMs may be characterized by a vast number of parameters, often ranging from tens of millions to billions. The large parameter count allows these models to capture complex language patterns and relationships during training.

In an example, the LLMs may be considered to be built on Transformer architecture, however, this should not be construed as a limitation. For example, the transformer architecture effectively captures long-range dependencies and contextual information in language. Moreover, the transformer architecture may use attention mechanisms to weigh the significance of different parts of an input sequence. In addition, the LLMs may employ bidirectional processing, allowing the models to consider context from both directions when analyzing a sequence of words. This bidirectional approach enhances the model's understanding of the context in which words appear. In an example, the LLMs may generate contextual representations of words, meaning that the representation of a word is influenced by its surrounding context. This enables the model to capture the meaning of words in different contexts.

Recently, the use of LLMs has increased manifold for a variety of language-related tasks, such as sentiment analysis, text classification, question answering, machine translation, summarization, and conversational agents. Due to the large number of parameters, training of LLMs from scratch is a time consuming and expensive process, and therefore, not preferable. To address this problem, pre-trained LLMs are used for generic tasks. For example, LLMs are typically pre-trained on extensive and diverse datasets containing a wide variety of text from the internet. Pre-training involves exposing the model to a broad range of language patterns, allowing it to learn general linguistic features. However, for performing domain-specific tasks, adaptation of LLMs for the particular domain needs to be performed. In one example, LLMs may leverage transfer learning where the model is pre-trained on a large corpus of data and then fine-tuned for specific tasks or domains. This approach enables the model to transfer the knowledge gained during pre-training to various downstream applications.

It may be noted, a base model in an LLM refers to a pre-trained model that has been trained on a large corpus of data for a general natural language understanding and generation task. The pre-trained model serves as a foundation for capturing broad linguistic patterns and knowledge from diverse sources. For example, in the context of pre-trained transformers, a base model is pre-trained on a massive dataset to predict the next word in a sequence, effectively learning grammar, context, and semantics from diverse language patterns.

In an example, the base model contains a large number of parameters and exhibits a high level of language understanding, making it a powerful starting point for a variety of natural language processing tasks. While the base model is pre-trained on a large corpus of general language data, fine-tuning or adapting the base model for specific tasks or domains enhances its performance and makes it more suitable for targeted applications.

Continuing further, an adapter refers to a smaller and task-specific module added to the base model to adapt the base model for a particular task or domain. The adapter includes a lightweight set of parameters that is trained on task-specific data while keeping all or majority of the base model's parameters frozen. In particular, the adapter is used to fine-tune the base model for a specific downstream task without extensively modifying its pre-trained parameters. This approach is beneficial when computational resources or labelled task-specific data are limited.

Similar to the first user device 204, each of the one or more electronic devices 208 may include suitable logic, circuitry, interfaces, and/or code that may be configured to receive a user input from the second entity 220 to register one or more domain names associated with the first trademark term. In an embodiment, the second entity 220 may register one or more domain names using one or more domain name registrars. Each domain name registrar of the one or more domain name registrars may manage a reservation of one or more internet domain names. In an embodiment, the second entity 220 may correspond to a stand-alone user or an organization. In an embodiment, each of the one or more electronic devices 208 may include a display screen. Examples of the each of the one or more electronic devices 208 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other device with computer vision display capabilities.

Each of the first set of databases 210, the second set of databases 212, and the third set of databases 214 may correspond to an organized collection of data that may be stored and accessed electronically from a computer system (such as the system 202). In an embodiment, the first set of databases 210 may be associated with one or more trademark registrars (such as The United States Patent and Trademark Office (USPTO) or The United Kingdom Intellectual Property Office (UKIPO)) and may store the registration information associated with a set of trademark terms that may include the first trademark term. The second set of databases 212 may be associated with the system 202 and may store a training dataset that may be used to train the first ML model 206A. The third set of databases 214 may be associated with one or more domain name registrars and may store the registration information associated with the one or more domain names registered by users such as the first entity 218, and the second entity 220.

Each of the first set of databases 210, the second set of databases 212, and the third set of databases 214 may be designed to manage, store, retrieve, and update data efficiently. The structure of each of the first set of databases 210, the second set of databases 212, and the third set of databases 214 base typically involves tables, records, and fields that can be managed through various database management systems (DBMS).

Examples of each of the first set of databases 210, the second set of databases 212, and the third set of databases 214 may include, but are not limited to, as a relational database, a Non-Structured Query Language (SQL) database, a hierarchical database, a network database, a transactional database, a data warehouse, and a distributed database.

The server 216 may include suitable logic, circuitry, and interfaces, and/or code that may be configured to first registration information and second registration information. The server 216 may be configured to store the first ML model 206A and the second ML model 206B. The server 216 may be implemented as a cloud server and may execute operations through web applications, cloud applications, HTTP requests, repository operations, file transfer, and the like. Other example implementations of the server 216 may include, but are not limited to, a database server, a file server, a web server, a media server, an application server, a mainframe server, or a cloud computing server.

In an embodiment of the disclosure, the server 216 may be implemented as a plurality of distributed cloud-based resources by use of several technologies that are well known to those ordinarily skilled in the art. A person with ordinary skill in the art will understand that the scope of the disclosure may not be limited to the implementation of the server 216 and the system 202 as two separate entities. In certain embodiments, the functionalities of the server 216 can be incorporated in its entirety or at least partially in the system 202, without a departure from the scope of the disclosure.

In operation, the system 202 may be configured to receive a first input associated with a first trademark term. In an embodiment, the first input may include the first registration information associated with registration of the first trademark term. The first trademark term may be registered by the first entity 218. In an embodiment, the system 202 may receive the first input from the first user device 204 associated with the first entity 218. In an alternate embodiment, the system 202 may receive the first input from the first set of databases 210 associated with the one or more trademark registrars.

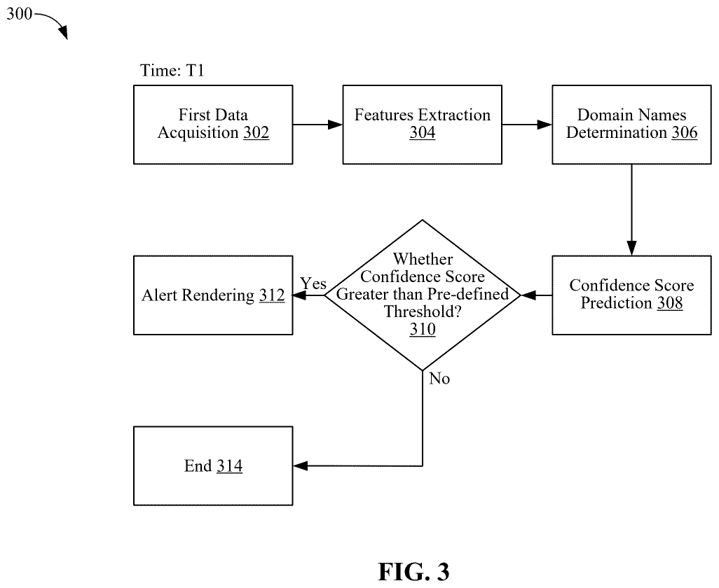

Based on the reception of the first input, the system 202 may be configured to determine a first set of features based on the received first input. The first set of features may be associated with the first trademark term and may include at least one of, but is not limited to, a length of the first trademark term, or classification information associated with the first trademark term. Details about the first set of features are provided, for example, in FIG. 3.

The system 202 may be further configured to provide the first set of features associated with the first trademark term, as an input, to the first ML model 206A. The first ML model 206A may be a pre-trained on the training dataset that includes a set of historical trademark terms and one or more cybersquatting events associated with each historical trademark term of the set of historical trademark terms. The training dataset may be stored in the second set of databases 210.

The system 202 may be further configured to receive a first confidence score, as an output, of the first ML model 206A. The first confidence score may be indicative of at least one cybersquatting event associated with the first trademark term. Specifically, the first confidence score may be indicative of a possibility of the at least one cybersquatting event associated with the first trademark term in future. The at least one cybersquatting event may correspond to a registration of one or more domain names associated with the first trademark term by the second entity 220 that may be different from the first entity 218.

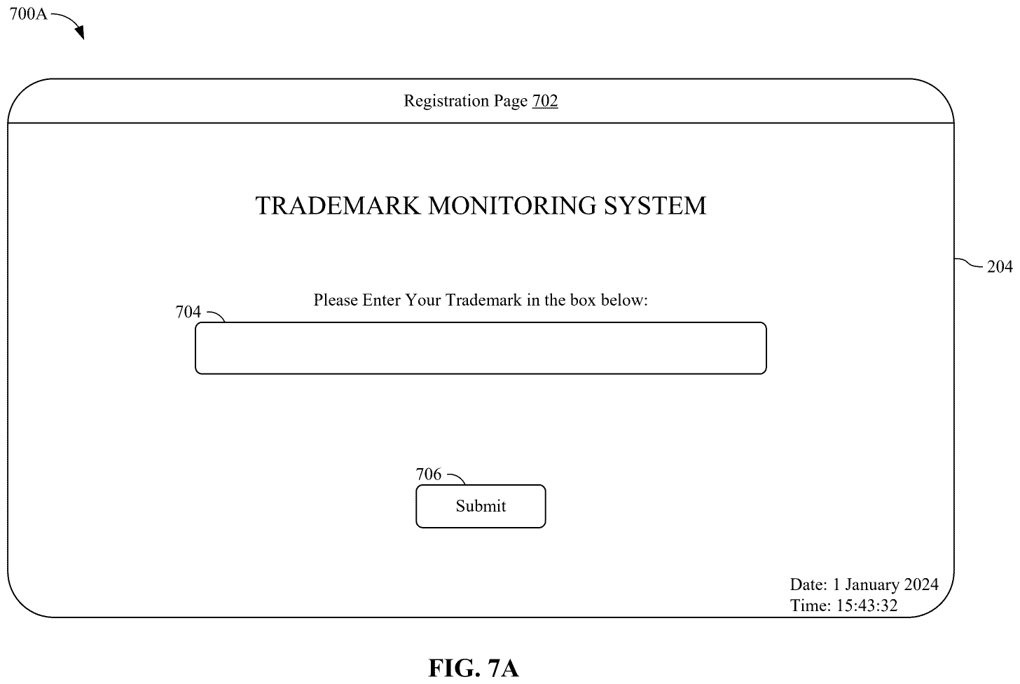

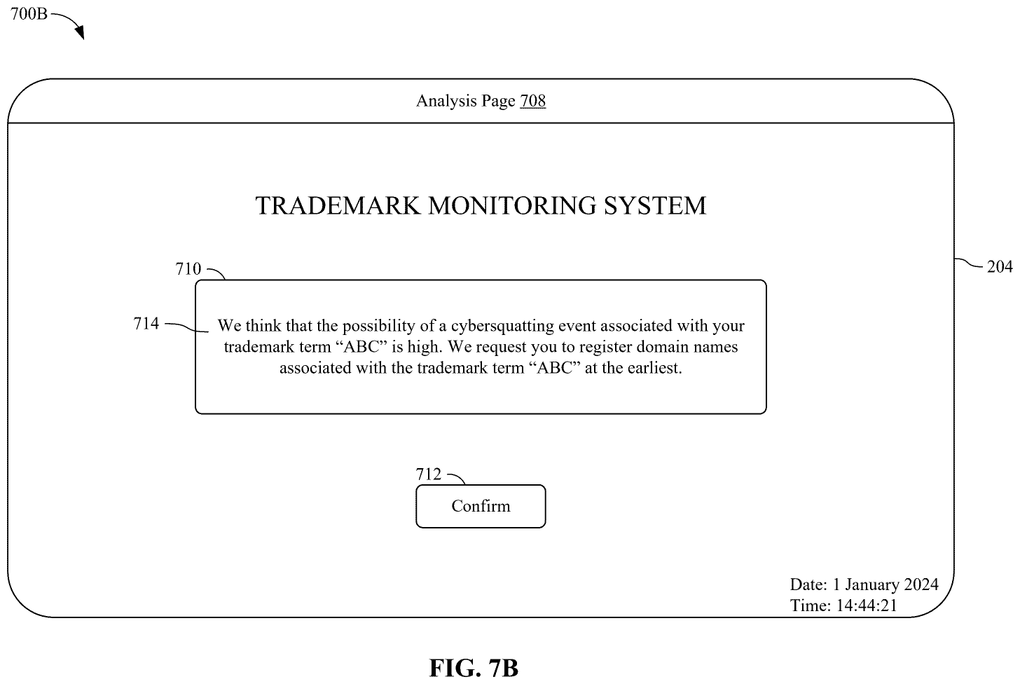

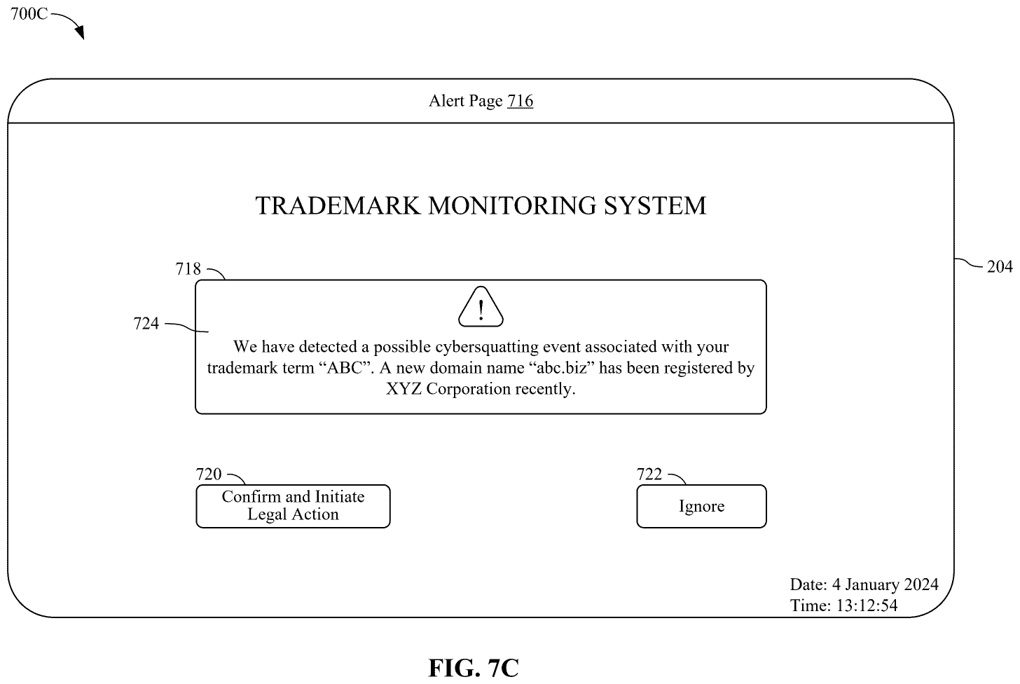

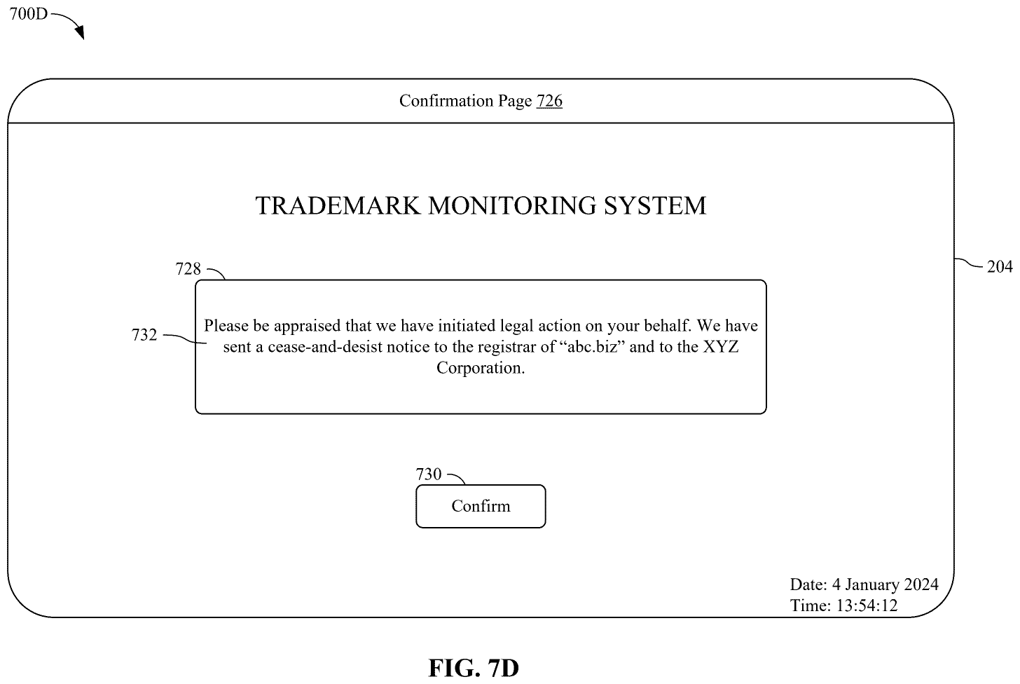

The system 202 may be further configured to render a first alert based on the received first confidence score as shown in FIG. 7B. In an embodiment, the system 202 may be configured to render the first alert on the first user device 204 associated with the first entity 218. The first alert may be indicative of a possibility of the at least one cybersquatting event associated with the first trademark term by at least the second entity 220 in future.

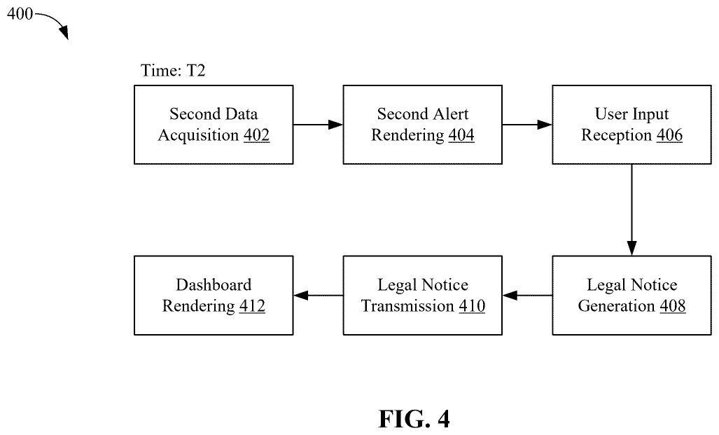

Further, the system 202 may be configured to continuously monitor the cybersquatting event. In an embodiment, the system 202 may be configured to monitor the third set of databases 214 for the first event associated with the registration of the one or more domain names. The third set of databases 214 may be associated with the one or more domain name registrars. Details about the one or more domain name registrars are provided, for example, in FIG. 4.

The system 202 may be further configured to retrieve first registration information associated with the registration of a first trademark term from the first set of databases 210. The system 202 may further retrieve second registration information associated with the registration of the one or more domain names based on a detection of the first event. The system 202 may be further configured to render a second alert based on a comparison of the retrieved first registration information and the retrieved second registration information. The second alert may be indicative of registration of the one or more domain names by the second entity 220. Details about the second alert are provided, for example, in FIG. 7C.

FIG. 3 is a diagram that illustrates exemplary operations for prediction of cybersquatting events, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 314, as described herein. The exemplary operations illustrated in the block diagram 300 may start at 302 and may be performed by any computing system, apparatus, or device, such as by the computer 102 of FIG. 1 or system 202 of FIG. 2. Although illustrated with discrete blocks, the exemplary operations associated with one or more blocks of the block diagram 300 may be divided into additional blocks, combined into fewer blocks, or eliminated, depending on the particular implementation.

The disclosed system 202 may work in two phases that may include a prediction phase and a prevention phase. In the prediction phase, the system 202 may predict the possibility of at least cybersquatting event with a trademark term whereas in the prevention phase, the cybersquatting event may have happened and the system 202 may provide legal support to the registrar of the first trademark term for blocking the one or more domain names. The prevention phase may happen after the prediction phase. Specifically, the operations in the prediction phase from 302 to 314 may be executed at time “T1” and the operations of the prevention phase may be executed at time “T2” after time “T1”. Details about the prevention phase are provided, for example, in FIG. 4.

At 302, a first data acquisition operation may be executed. In the first data acquisition operation, the system 202 may be configured to receive a first input associated with a first trademark term. Specifically, the first input may include the trademark term. In an embodiment, the first input may be received from the first user device 204 that may be associated with the first entity 218 who may be the owner (or registrar) of the trademark term. In an alternate embodiment, the first entity 218 may have a license to use the trademark term. Details about the first input are provided, for example, in FIG. 7A.

In an alternate embodiment, the first input may include the first registration information that may be associated with the trademark term. In such an embodiment, the first input may be received from the first set of databases 210 where registration information of the trademark terms may be stored. The registration information may include information about the first trademark term, an owner of the first trademark term, entities who may have licensed the first trademark terms, contact details of the owner of the first trademark term, and the like.

In an embodiment, the system 202 may be configured to utilize web crawling techniques and application programming interfaces (APIs) to continuously scan the first set of databases 210 to retrieve the first registration information associated with the registration of the first trademark term. In an embodiment, the processor set 114 may include a trademark monitoring module that may be configured to retrieve the first registration information form the first set of databases 210.

At 304, a features extraction operation may be executed. In the features extraction operation, the system 202 may be configured to extract a first set of features that may be associated with the first trademark term that may be received as the first input at 302. In an embodiment, the first set of features may include, but are not limited to, a length of the first trademark term, and classification information associated with the first trademark term. By way of example, if the first trademark term is “ABC”, then the length of the first trademark term may be 3.

The classification information may be indicative of goods or services that the first entity 218 might offer using the terms. For example, the first trademark term “ABC” might be used to provide entertainment services. In such scenario, the classification information may indicate “entertainment” as one of the services. The classification information may be used in the prediction of the confidence score as for the trademark terms that provide a certain types pf services (like the entertainment services) may have a higher chance of being cybersquatted as per historical trends. In an embodiment, a feature determination module of the processor set 114 may be configured to perform the above operation of determining the first set of features.

At 306, a domain names determination operation may be executed. In the domain names determination operation, the system 202 may be configured to determine one or more domain names associated with the first trademark term. Specifically, the system 202 may be configured to determine one or more domain names that may be semantically similar to the first trademark term. In an embodiment, the system 202 may be configured to determine the one or more domain names based on natural language processing (NLP) of the first trademark term. Specifically, the system 202 may apply one or more NLP techniques on the first trademark term to determine the one or more domain names. In some embodiments, the system 202 may be configured to determine the one or more domain names based on the first set of features associated with the first trademark term. Specifically, the system 202 may further utilize historical trends associated with historical cybersquatting events associated with historical trademark terms having features similar to the first set of features. Such historical trends may be stored in the second set of databases 212 associated with the system 202.

In an embodiment, the system 202 may determine the one or more domain names using one or more regular expressions. In accordance with the first example, if the first trademark term is “ABC”, then the one or more domain names may include, but are not limited to, “abc.com”, “abc.us”, “abc.edu”, “abc.net”, “abc.io”, “abc.co”, “abc.net”, “abc1.com”, “aabc.com”, “1abc.com”, “abbc.com”.

At 308, a confidence score prediction operation may be executed. In the confidence score prediction operation, the system 202 may be configured to apply the first ML model 206A of the set of ML models 206 on the determined set of features and the determined one or more domain names. Based on the application of the first ML model 206A on the determined set of features and the determined one or more domain names, the system 202 may predict a first confidence score for each domain name of the determined one or more domain names. The first confidence score may be indicative of at least one cybersquatting event associated with the first trademark term. Specifically, the first confidence score may be indicative of a possibility of the at least one cybersquatting event associated with the first trademark term in future. The at least one cybersquatting event corresponds to a registration of one or more domain names associated with the first trademark term by the second entity 220 who may be different from the first entity 218. As discussed above, the first trademark term may be registered by the first entity 218.

In an alternate embodiment, the system 202 may be configured to predict a confidence score associated with each of the one or more domain names associated with the first trademark term. Such confidence score may be indicative of the possibility of the registration of the corresponding domain name by the second entity 220. In an embodiment, the confidence score may be a measure of how certain the first ML model 206A of the set of ML models 206 is about its prediction of a given input. The confidence score may be typically expressed as a value between 0 and 1, with 1 indicating the highest level of confidence and 0 indicating the lowest level of confidence.

In an embodiment, the processor set 114 may include an artificial intelligence (AI)-based trademark recognition module. This AI-based trademark recognition module may process the collected domain data in real-time, utilizing natural language processing (NLP) and machine learning models to identify matches with trademarked terms, brand names, and suspicious keyword patterns to predict the first confidence score. The system 202 may be further configured to continuously refine its recognition accuracy by incorporating historical data and machine learning techniques. In an embodiment, the confidence score prediction operation executed at 304 may be performed by the AI-based trademark recognition module.

At 310, it may be determined whether the determined first confidence score is greater than a pre-defined threshold. In an embodiment, the pre-defined threshold may correspond to a minimum value of the confidence score for consideration of a possibility of the at least one cybersquatting event. By way of example and not limitation, the pre-defined threshold may be 0.5. In case the first confidence score is greater than the pre-defined threshold, then the control may be transferred to 312. Otherwise, the control may be transferred to end at 314.

At 312, an alert rendering operation may be executed. In the alert rendering operation, the system 202 may be configured to a render first alert based on the predicted first confidence score. The first alert may be rendered on the first user device 204 associated with the first entity 218 and may indicate that the possibility of the cybersquatting event associated with the first trademark term (registered by the first entity 218) may be high. Furthermore, the rendered first alert may include recommendations for the first entity 218 to register the one or more domain names associated with the first trademark term. Details about the first alert are provided, for example, in FIG. 7B.

FIG. 4 is a diagram that illustrates exemplary operations for prevention of cybersquatting events, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402 to 412, as described herein. The exemplary operations illustrated in the block diagram 400 may start at 402 and may be performed by any computing system, apparatus, or device, such as by the computer 102 of FIG. 1 or system 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402, a second data acquisition operation may be executed. In the second data acquisition operation, the system 202 may be configured to retrieve second registration information. The second registration information may be associated with registration of the one or more domain names by the second entity. Specifically, the second registration information may be indicative of the second entity trying to register the one or more domain names associated with the first trademark term. In another embodiment, the second registration information may indicate that the one or more domain names have been registered or are being registered by the second entity 220 different from the first entity 218.

In an embodiment, the system 202 may retrieve the second registration information from the third set of databases 214. In an embodiment, the third set of databases 214 may be associated with the one or more domain name registrars. Each of the one or more domain name registrars may correspond to organizations that may be accredited by the Internet Corporation for Assigned Names and Numbers (ICANN) to manage the reservation of internet domain names (such as the one or more domain names). Each of the one or more domain name registrars may provide services for registering domain names and ensuring they are associated with a specific internet protocol (IP) address to be accessible on the internet.

In an embodiment, the system 202 may be configured to monitor the third set of databases 214 for a first event associated with a registration of one or more domain names. The first event may be triggered/detected when the third set of databases 214 may be updated with the registration of the one or more domain names by the second entity. In an embodiment, the system 202 may employ a publisher-subscriber architecture that may facilitate real-time data updates and event-driven interactions. In this model, publishers (or the third set of databases 214) may correspond to entities that may generate data changes or events, which may be then transmitted to the subscribers (or the system 202). The subscriber (or the system 202) may receive the data changes or events and further processes them accordingly as described below from 404.

In another implementation, the system 202 may execute an Extract, Transform, Load (ETL) process. In such an implementation, the system 202 may be configured to periodically extract new data from the third set of databases 214 and further retrieve relevant data from the new data. In an embodiment, the relevant data may correspond to the second registration information. The system 202 may further processes the retrieved relevant data accordingly as described below from 404.

In another implementation, the new data that may be published in the third set of databases 214 may be automatically received by the system 202 using a database replication mechanism that may be implemented between the third set of databases 214 and the second set of databases 212 associated with the system 202. The system 202 may further process the data accordingly as described below from 404.

In another implementation, the system 202 may be configured to use web crawling or application programming interfaces (APIs) techniques to retrieve the second registration information from the third set of databases 214. Details about the web crawling and API techniques are already known in the art and have not been added for the sake of brevity.

In an embodiment, the system 202 may be further configured to retrieve first registration information that may be associated with the registration of the first trademark term. In such an embodiment, the first input may be received from the first set of databases 210 where registration information of the trademark terms may be stored. The registration information may include information about the first trademark term, an owner of the first trademark term, entities who may have licensed the first trademark terms, contact details of the owner of the first trademark term, and the like. Details about the retrieval of the first trademark term are provided, for example, in FIG. 3.

At 404, an alert rendering operation may be executed. In the alert rendering operation, the system 202 may be configured to render a second alert on the first user device 204 associated with the first entity 218. The second alert may be rendered based on the comparison of the first registration information and the retrieved second registration information. Specifically, the second alert may be generated if the registrar of the one or more domain names is different from the registrar of the first trademark term. The first registration information may include the registrar of the first trademark term and the second registration information may include the registrar of the one or more domain names. The second alert may indicate that the one or more domain names similar to the first trademark term is being registered or have been registered by the second entity 220. Details about the second alert are provided, for example, in FIG. 7C.

Therefore, the disclosed system 202 generates real-time alerts and notifications upon detecting potential cybersquatting events. Such alerts may be customizable and may be delivered to entities, including trademark owners, legal teams, and administrators, via electronic mail (e mail), short message service (SMS), or any other communication means so that the entities are promptly informed of potential threats, thereby allowing them to take an immediate action (such as initiation of a legal action).

At 406, a user input reception operation may be executed. In the user input reception operation, the system 202 may be configured to receive second user input. The second user input may be received based on the transmission of the rendered second alert. In an embodiment, the second alert may include a user interface (UI) element that may be a button. Based on the selection of the first UI element by the first entity 218 via the first user device 204, the system 202 may receive the second user input associated with the transmission of a legal notice to the one or more databases. In an embodiment, the one or more databases may be associated with the one or more domain name registrars. In an embodiment, the one or more databases may be associated with the second entity 220.

At 408, a legal notice generation operation may be performed. In the legal notice generation operation, the system 202 may be configured to generate the legal notice to be transmitted to the one or more electronic devices associated with the second entity 220 or the one or more domain name registrars. In an embodiment, the system 202 may be configured to generate the legal notice based on the jurisdiction of the one or more domain name registers and/or the second entity 220. This may be done to incorporate relevant local laws and regulations while generating the legal notice. Furthermore, the system 202 may be configured to generate the legal notice in an official language of the jurisdiction.

In an embodiment, the legal notice may correspond to a cease-and-desist notice. The cease-and-desist notice may be a formal written communication sent to the second entity 220 and/or the one or more domain name registrars, demanding that the second entity 220 or the one or more domain name registrars immediately stop engaging (or using) the one or more domain names perceived as infringing upon the first trademark term. With respect to the disclosure, a domain name cease-and-desist notice may be sent by a trademark owner (i.e. the first entity 218) to the second entity 220 who may be using a domain name that is similar to the first trademark term. The cease-and-desist notice may demand that the domain name registrant immediately stop using the one or more domain names and transfer the registration of the one or more domain names to the first entity 218. The cease-and-desist notice may further allege that the one or more domain names infringes on the rights of the owner of the first trademark term and may be causing consumer confusion.

In an embodiment, the system 202 may be configured to generate the legal notice using the second ML model 206B of the set of ML models 206. As discussed above, the second ML model 206B may correspond to the language model. Specifically, the system 202 may be configured to generate the legal notice based on the application of the second ML model 206B on the first registration information, and the second registration information.

In an alternate embodiment, the system 202 may transmit a request to an electronic device associated with a partnering law firm who may specialize in intellectual property rights. Based on the reception of the request from the system 202, the employees of the partnering law firm may draft the legal notice on behalf of the first entity 218.

At 410, a legal notice transmission operation may be executed. In the legal notice transmission operation, the system 202 may be configured to transmit the legal notice to the one or more electronic devices. As discussed above, the one or more electronic devices may be associated with the one or more domain name registrars and/or the second entity 220. In an embodiment, the processor set 114 of the computer 102 may include a legal assistance module. The operations described at 408 and 410 may be performed by the legal assistance module that may be integrated within the computer 102.

In an embodiment, the system 202 maintains communication channels with domain name registries and the one or more domain name registrars worldwide through one or more standardized protocols. This global registry cooperation module ensures timely responses to domain blocking and legal actions. It also maintains a directory of accredited registrars for quick reference.

At 412, a dashboard rendering operation may be performed. In the dashboard rendering operation, the system 202 may be configured to render a dashboard on the first user device 204. The system 202 may be continuously monitor whether the one or more domain names are accessible or not after the transmission of the legal notice to the one or more electronic devices and further display a status associated with the accessibility of the one or more domain names on the dashboard. Furthermore, the first entity 218 may be able to monitor the status of their trademarked terms, track historical data related to cybersquatting cases, and assess the effectiveness of their anti-cybersquatting efforts. Therefore, the disclosed system 202 may provide users with real-time dashboards and reporting tools to support informed decision-making and strategy development.

Hence, the disclosed system 202 offers substantial business value by effectively combating cybersquatting, protecting brands, and minimizing financial risks. The disclosed system 202 further streamlines the process of identifying and preventing cybersquatting attempts, reducing the time and resources needed for legal actions. Additionally, the disclosed system 202 promotes transparency in domain registration, fostering fairness and equity in the online landscape. Overall, the disclosed system 202 provides a comprehensive and proactive solution to the persistent challenge of cybersquatting, enhancing the online presence and reputation of businesses while saving them significant financial losses.

In an embodiment, the disclosed system 202 may be a blockchain-based ledger system to record and verify the authenticity and ownership of the one or more domain names. The disclosed system 202 may utilize one or more smart contracts to automate the validation process and ensure that once a domain name is registered to the trademark term, any future registration attempts of similar domain names may trigger a smart contract that automatically blocks registration unless approved by the trademark owner. Further, the disclosed system 202 may further create a decentralized authentication protocol for registrars to cross-verify domain name registration requests against the blockchain ledger, enhancing the integrity and security of domain name ownership.

In an embodiment, the disclosed system 202 may implement a big data analytics platform that may use predictive modeling to forecast trending keywords and potential new trademarks based on social media, news outlets, and market analysis. Such a platform may proactively reserve or monitor domain names that are likely to become targets of cybersquatting, based on predictive insights, before trademark owners even register them. Furthermore, the such platform may be used to develop an ‘early warning’ system for businesses to suggest the pre-emptive acquisition or defense of domain names that align with current or expected branding trends identified through market sentiment analysis.

In an alternate embodiment, the disclosed system 202 may create a community-driven platform where users may be able contribute to the monitoring and reporting of potential cybersquatting activities. The disclosed system 202 may further gamify the identification process with rewards for verified contributors who first report a potential case of cybersquatting. The disclosed system 202 may further incorporate a reputation system that may leverages collective intelligence and rewards the community for maintaining a cybersquatting-free ecosystem, thereby crowdsourcing part of the monitoring efforts and empowering users to protect their own online neighborhoods.

In an embodiment, the disclosed method may be implemented as a standalone cybersquatting prediction and prevention system. In an alternate embodiment, the disclosed method may be implemented in at least one server that may be associated with the one or more domain name registrars. In such an implementation, the method may trigger a warning to an entity who may be trying to register a domain name similar to a trademark term by a different entity. In such an implementation, the server may communicate with the first set of databases 210 to retrieve the registration information associated with the trademark terms stored in the first set of databases 210. In an alternate embodiment, the disclosed method may be implemented in at least one server associated with the one or more trademark registrars. In such an implementation, the server may render recommendations to the entity who may have registered a trademark term. The recommendations may be associated with registering one or more domain names associated with the trademark term to prevent cybersquatting events associated with the trademark term in future.

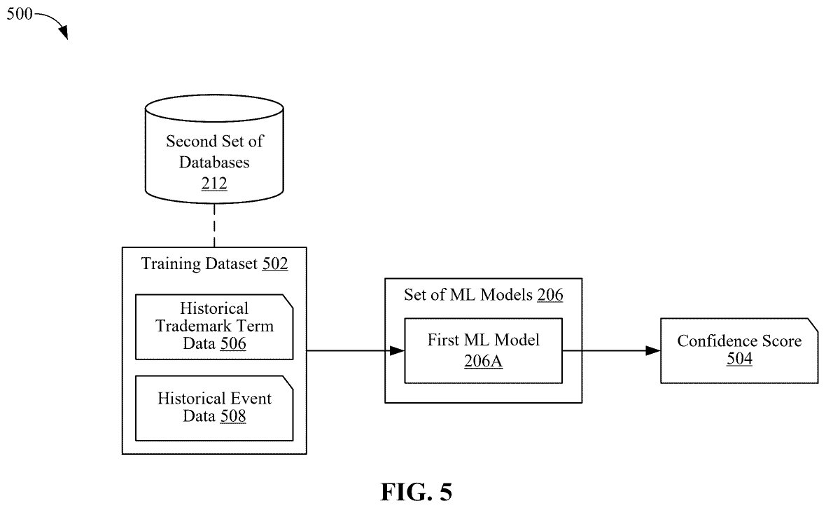

FIG. 5 is a diagram depicting training of the first ML model for the prediction of confidence score associated with a possibility of a cybersquatting event, according to one embodiment. With reference to FIG. 5, there is shown a diagram 500. The diagram 500 may include the first ML model 206A, a training dataset 502, and a confidence score 504. The training dataset 502 may include historical trademark term data 506 and historical event data 508 associated with one or more cybersquatting events. The one or more cybersquatting events may be associated with each historical trademark term of a set of historical trademark terms.

In an embodiment, the training dataset 502 including the historical trademark term data 506 and the historical event data 508 related to cybersquatting incidents may be a crucial asset for developing (and improving the performance) of the first ML model 206A. Each trademark term in the dataset may be linked to one or more cybersquatting events, thereby providing a comprehensive view of how and when these trademarks were targeted in the past.

In an embodiment, the historical trademark term data 506 may be associated with the set of historical trademark terms. The historical trademark term data 506 may include, but are not limited to, a trademark term, a registration date of the corresponding trademark term, and an owner of the trademark term, a set of features associated with the trademark term, and the like. The set of features may include, but is not limited to, the length of the corresponding trademark term, and the classification information associated with the corresponding trademark term.

The historical event data 508 for each cybersquatting incident encompasses various attributes, such as the domain names involved, registration dates, registrar details, and the like. Additionally, it includes the content hosted on these domains, traffic data, and outcomes of any legal proceedings, such as Uniform Dispute Resolution Policy (UDRP) decisions or court rulings. By capturing these diverse data points, the training dataset 502 allows for a multifaceted analysis of cybersquatting activities, highlighting how cybersquatters (or the second entity 220) operate and the strategies they employ to exploit trademark terms.

In an embodiment, the system 202 may be configured to calculate an interval between the registration date of the trademark term and the registration date of the one or more domain names associated with the corresponding trademark term. The registration date of the trademark term may be included in the historical trademark term data 506 associated with the corresponding trademark term and the registration date of the one or more domain names may be included in the historical event data 508 associated with the corresponding trademark term. The system 202 may be further configured to include the calculated interval associated with each historical trademark term of the set of historical trademark terms, as a feature, in the training dataset. The calculated interval may be used for the prediction of the confidence scores. It may be noted that if the calculated interval is less than a pre-defined interval (say 5 days), then the corresponding confidence score may be high (say a first value). Otherwise, the confidence score may be low (say a second value that may be less than the first value).

Using this rich training dataset 512, the system 202 may be configured to train the first ML model 206A of the set of ML models 206 to recognize the likelihood of cybersquatting events for given trademark terms (say the first trademark term). The model analyzes historical patterns and correlations within the data, learning to identify the subtle indicators that suggest the one or more domain names might be registered with malicious intent. As a result, the trained model can output a confidence score for indicating the probability of a cybersquatting event associated with the given trademark term. This score helps trademark owners and registrars to preemptively address potential threats, mitigating the risks associated with cybersquatting.

The predictive power of the first ML model 206A may rely heavily on the quality and comprehensiveness of the training dataset 502. A well-curated dataset that captures the nuances of historical cybersquatting events enables the first ML model 206A to make accurate and reliable predictions. By continuously updating the dataset with new cybersquatting events and evolving trends, the first ML model 206A may adapt to emerging tactics used by cybersquatters, ensuring it remains an effective tool for protecting trademark owners from fraudulent domain registrations.

In an embodiment, the system 202 may be configured to store the training dataset 502 in the second set of databases 212. To train the first ML model 206A, the system 202 may be configured to retrieve the training dataset 502 from the second set of databases 212 and train the first ML model 206A. In an embodiment, the system 202 may be configured to store the first registration information associated with the first trademark term and the second registration information associated with the one or more domain names in the second set of databases 212. In a future training event, the first trademark term and the second registration information associated with the one or more domain names in the second set of databases 212 may be considered as historical data.

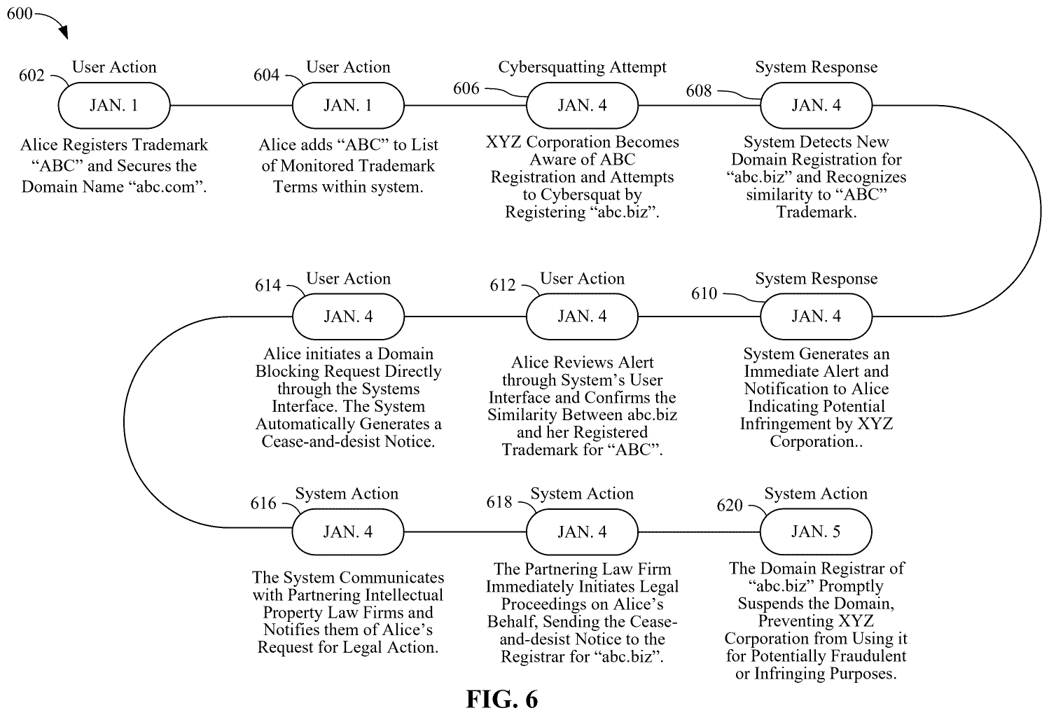

FIG. 6 is a diagram that illustrates an exemplary timeline for prevention of an exemplary cybersquatting event, in accordance with an embodiment of the disclosure. FIG. 6 is explained in conjunction with elements from FIG. 1, FIG. 2, FIG. 3, FIG. 4, FIG. 5, and FIG. 6. With reference to FIG. 6, there is shown an exemplary timeline 600 that depicts user actions and system actions as and when they happen. The user actions may be performed by a user (or the first entity 218) and the system actions may be performed by the disclosed system 202.

At 602, a first user action may be performed at time T1 (say on January 1). In the first action, the user (or the first entity 218) “Alice” may register a trademark term “ABC” and registers a first domain name “abc.com” on January 1. On the same day, the user “Alice” may add the trademark term “ABC” to a list of trademark terms to be monitored by the disclosed system 202 for a cybersquatting event as shown at 604. The disclosed system 202 may continuously monitor for the trademark term “ABC” for cybersquatting events as soon as the user “Alice” adds the trademark term “ABC” to the list of trademark terms.

At 606, a cybersquatting event may happen on Jan. 4, 2024. As shown in the FIG. 6, a second entity “XYZ Corporation” may attempt to cybersquat by registering a second domain name “abc.biz”. On the same day (i.e. January 4), the disclosed system 202 may detect a new domain registration for the second domain name “abc.biz” and recognizes a similarity of the second domain name “abc.biz” with the trademark term “ABC” as described at 608. The system 202 may perform this system action as soon as the registration information for the second domain name “abc.biz” may be received from a set of databases (or the third set of databases 214) that may be related to the one or more domain name registrars.

At 610, the system 202 may generate an alert (or a notification) and transmits the generated alert to an electronic device associated with the user “Alice”. The generated alert may indicate a potential infringement of the trademark term “ABC” by the second entity “XYZ Corporation”. At 612, the user “Alice” may review the received alert and may transmit an input indicating a confirmation between the domain name “abc.biz” and the trademark term “ABC”. At 614, the user “Alice” may initiate a domain blocking request directly through a user interface of the disclosed system 202 as shown in FIGS. 7A-7D.

The system 202 may be further configured to automatically generate a cease-and-desist notice using the second ML model 206B based on the information associated with the user “Alice”, the information associated with the second entity “XYZ Corporation”, information associated with the registration of the second domain name “abc.biz”, and the trademark term “ABC”.

At 616, the disclosed system 202 may communicate with a partnering intellectual property law firm and notifies the partnering intellectual property law firms about the request for legal action initiated by the user “Alice”. At 618, the partnering law firm may immediately initiate the legal proceedings on behalf of the first entity “Alice”. The partnering law firm may transmit (either electronically or physically) the cease-and-desist notice to the registrar of the second domain name “abc.biz”. As soon as the registrar receives the cease-and-desist notice from the partnering law firm, the domain registrar of “abc.biz” may promptly suspend the second domain name “abc.biz”, thereby preventing the second entity “XYZ Corporation” from using the second domain name “abc.biz” for potentially fraudulent or infringing purposes as shown at 620.

As shown in the FIG. 6, the system 202 may promptly initiate legal action against the second entity “XYZ Corporation”. This may result in the suspension of the second domain name “abc.biz” with 1-2 days of the registration of the second domain name “abc.biz”.

FIG. 7A is diagram that depicts exemplary registration page for monitoring a trademark term, in accordance with an embodiment of the disclosure. FIG. 7A is explained in conjunction with elements from FIG. 1, FIG. 2, FIG. 3, FIG. 4, FIG. 5, and FIG. 6. With reference to FIG. 7A, there is shown an exemplary diagram 700A that includes an exemplary registration page 702 that may include a first user interface (UI) element 704, and a second UI element 706.

The registration page 702 may correspond to a web page or online form that may be designed to collect information from entities (or users) who wish to monitor their trademark terms. The registration page 702 may be used to gather relevant details from the entities to facilitate them in monitoring their trademark terms.

The first UI element 704 may correspond to a textbox where the entity may write their trademark terms to be monitored. The trademark term may be a unique identifier that may identify a product or service from a particular source and distinguishes it from others. With reference to FIG. 6, the user “Alice” may type the trademark term “ABC” in the textbox. The second UI element 706 may correspond to a button and may be labelled as “Submit”. Upon selecting the second UI element 706, the system 202 may receive the input and further initiates monitoring of the trademark term.

FIG. 7B is diagram that depicts exemplary analysis page associated with a possibility of the cybersquatting event associated with the trademark term, in accordance with an embodiment of the disclosure. FIG. 7B is explained in conjunction with elements from FIG. 1, FIG. 2, FIG. 3, FIG. 4, FIG. 5, FIG. 6, and FIG. 7A. With reference to FIG. 7B, there is shown an exemplary diagram 700B that includes an exemplary analysis page 708 that may include a third user interface (UI) element 710, and a fourth UI element 712.

The analysis page 708 may correspond to a web page that may render an analysis message 714 after the system 202 predicts the first confidence score indicative of at least one cybersquatting event associated with the first trademark term based on application of the first ML model 206A on the first set of features associated with the trademark term.

The third UI element 710 may correspond to a textbox and may include the analysis message 714. The fourth UI element 712 may correspond to a button and may be labelled as “Confirm”. Upon selection of the fourth UI element 712, the system 202 may receive information indicating that the analysis message 714 has been read by the user “Alice”.

FIG. 7C is diagram that depicts exemplary alert after the detection of a cybersquatting event associated with the trademark term, in accordance with an embodiment of the disclosure. FIG. 7C is explained in conjunction with elements from FIG. 1, FIG. 2, FIG. 3, FIG. 4, FIG. 5, FIG. 6, FIG. 7A, and FIG. 7B. With reference to FIG. 7C, there is shown an exemplary diagram 700C that includes an exemplary alert page 716 that may include a fifth user interface (UI) element 718, a sixth UI element 720, and a seventh UI element 722.

The alert page 716 may correspond to a web page that may render an alert message 724 after the system 202 detects a cybersquatting event associated with the trademark term. With reference to FIG. 6, the alert message 724 may be rendered on the electronic device associated with the user “Alice” after the second domain name “abc.biz” may be registered by the second entity “XYZ Corporation”. The alert message 724 may be indicative of the registration of the second domain name “abc.biz” by the second entity “XYZ Corporation”.

The fifth UI element 718 may correspond to a textbox and may include the alert message 724. The sixth UI element 720 and the seventh UI element 722 may correspond to a button. The sixth UI element 720 may be labelled as “Confirm and Initiate Legal Action” and the seventh UI element 722 may be labelled as “Ignore”. Upon selection of the sixth UI element 720, the system 202 may generate the legal notice and transmit it to the one or more electronic devices associated with at least one the second entity, or domain registrar of the second domain name. Upon selection of the seventh UI element 722, the system 202 may continue monitoring other cybersquatting events associated with the trademark term “ABC”.

FIG. 7D is diagram that depicts exemplary conformation message after the transmission of the legal notice to the one or more electronic devices, in accordance with an embodiment of the disclosure. FIG. 7D is explained in conjunction with elements from FIG. 1, FIG. 2, FIG. 3, FIG. 4, FIG. 5, FIG. 6, FIG. 7A, FIG. 7B, and FIG. 7C. With reference to FIG. 7D, there is shown an exemplary diagram 700D that includes an exemplary confirmation page 726 that may include an eighth user interface (UI) element 728, and a ninth UI element 730.

The confirmation page 726 may correspond to a web page that may render a confirmation message 732 after the system 202 transmits the legal notice to the one or more electronic devices associated with the domain registrar of the second domain name. With reference to FIG. 6, the confirmation message 732 may be rendered on the electronic device associated with the user “Alice”. The confirmation message 732 may be indicative of the transmission of the legal notice to domain registrars of the second domain name “abc.biz” and/or the second entity “XYZ Corporation”.

The eighth UI element 728 may correspond to a textbox and may include the confirmation message 732. The ninth UI element 730 may correspond to a button and may be labelled as “Confirm” Upon selection of the ninth UI element 730, the system 202 may receive information indicating that the confirmation message 732 has been read by the user “Alice”.

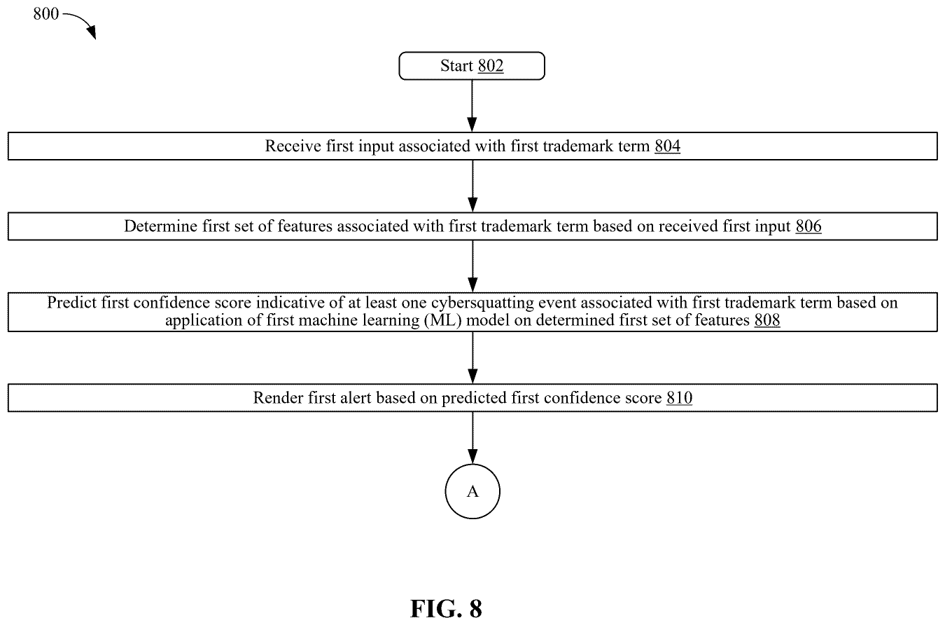

FIG. 8 is a flowchart that illustrates an exemplary method for prediction of cybersquatting events, in accordance with an embodiment of the disclosure. FIG. 8 is explained in conjunction with elements from FIG. 1, FIG. 2, FIG. 3, FIG. 4, FIG. 5, FIG. 6, FIG. 7A, FIG. 7B, FIG. 7C, and FIG. 7D. With reference to FIG. 8, there is shown a flowchart 800. The operations of the exemplary method may be executed by any computing system, for example, by the computer 102 of FIG. 1 or the system 202 of FIG. 2. The operations of the flowchart 800 may start at 802.

At 804, a first input associated with a first trademark term may be received. In an embodiment of the disclosure, the system 202 may be configured to receive the first input associated with the first trademark term. Details about the reception of the first input are provided, for example, in FIG. 3, and FIG. 7A.

At 806, the first set of features associated with the first trademark term may be determined based on the received first input. In an embodiment of the disclosure, the system 202 may be configured to determine the first set of features associated with the first trademark term based on the received first input. Details about the first set of features are provided, for example, in FIG. 3.

At 808, the first confidence score may be predicted based on application of the first ML model 206A on the determined first set of features. The first confidence score may be indicative of at least one cybersquatting event associated with the first trademark term. In an embodiment of the disclosure, the system 202 may be configured to predict the first confidence score indicative of at least one cybersquatting event associated with the first trademark term based on application of the first ML model on the determined first set of features. Details about the first confidence score are provided, for example, in FIG. 3.

At 810, the first alert may be rendered based on the predicted first confidence score. In an embodiment of the disclosure, the system 202 may be configured to render the first alert based on the predicted first confidence score. Details about the rendering of the first alert are provided, for example, in FIG. 7B. Control may pass to the end.

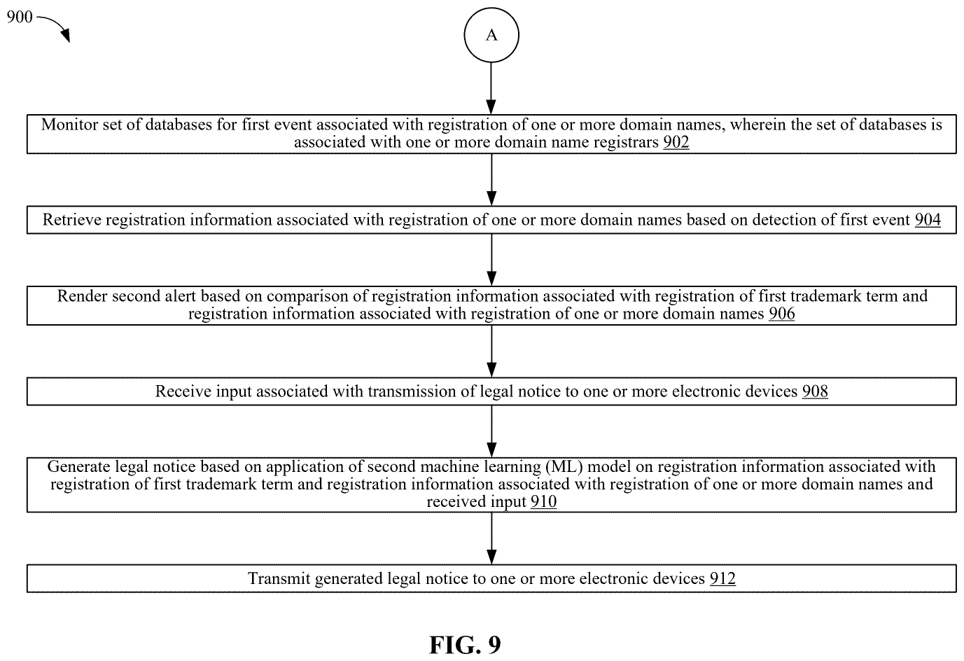

FIG. 9 is a flowchart that illustrates an exemplary method for prevention of cybersquatting events, in accordance with an embodiment of the disclosure. FIG. 9 is explained in conjunction with elements from FIG. 1, FIG. 2, FIG. 3, FIG. 4, FIG. 5, FIG. 6, FIG. 7A, FIG. 7B, FIG. 7C, FIG. 7D, and FIG. 8. With reference to FIG. 9, there is shown a flowchart 900. The operations of the exemplary method may be executed by any computing system, for example, by the computer 102 of FIG. 1 or the system 202 of FIG. 2. The operations of the flowchart 900 may start at 902.

At 902, the set of databases may be monitored for a first event associated with the registration of the one or more domain names. The set of databases may be associated with one or more domain name registrars. In an embodiment of the disclosure, the system 202 may be configured to monitor the set of databases for the first event associated with the registration of the one or more domain names, wherein the set of databases is associated with one or more domain name registrars. Details about the monitoring of the set of databases are provided, for example, in FIG. 2, and FIG. 4.

At 904, the registration information associated with the registration of the one or more domain names may be retrieved based on the detection of the first event. In an embodiment of the disclosure, the system 202 may be configured to retrieve the registration information associated with the registration of the one or more domain names based on the detection of the first event. Details about the registration information are provided, for example, in FIG. 4.

At 906, the second alert may be rendered based on the comparison of the registration information associated with registration of the first trademark term and the registration information associated with the registration of the one or more domain names. In an embodiment of the disclosure, the system 202 may be configured to render the second alert based on the comparison of registration information associated with the registration of first trademark term and the registration information associated with the registration of one or more domain names. Details about the second alert are provided, for example, in FIG. 4, and FIG. 7C.

At 908, an input associated with a transmission of a legal notice to one or more electronic devices may be received. In an embodiment of the disclosure, the system 202 may be configured to receive the input associated with the transmission of the legal notice to the one or more electronic devices. Details about the reception of the input associated with the transmission of the legal notice are provided, for example, in FIG. 4.

At 910, a legal notice may be generated based on application of the second ML model 206B on the registration information associated with registration of first trademark term and registration information associated with registration of one or more domain names and the received input. In an embodiment of the disclosure, the system 202 may be configured to generate the legal notice based on the application of the second ML model 206B on the registration information associated with the registration of the first trademark term and the registration information associated with the registration of the one or more domain names and the received input. Details about the legal notice are provided, for example, in FIG. 2, and FIG. 4.

At 912, the generated legal notice may be transmitted to one or more electronic devices. In an embodiment of the disclosure, the system 202 may be configured to transmit the generated legal notice to the one or more electronic devices. Control may pass to the end.

Various embodiments of the disclosure may provide a non-transitory computer readable medium and/or storage medium having stored thereon, instructions executable by a machine and/or a computer to operate a system (e.g., the system 202) for prediction and prevention of cybersquatting events. The instructions may cause the machine and/or computer to perform operations that include receiving a first input associated with a first trademark term. The operations further include determining a first set of features associated with the first trademark term based on the received first input. The operations further include predicting a first confidence score indicative of at least one cybersquatting event associated with the first trademark term based on application of a first machine learning (ML) model on the determined first set of features. The operations further include rendering a first alert based on the predicted first confidence score.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, a first input associated with a first trademark term;
determining, by the computer, a first set of features associated with the first trademark term based on the received first input;
predicting, by the computer, a first confidence score indicative of at least one cybersquatting event associated with the first trademark term based on application of a first machine learning (ML) model on the determined first set of features; and
rendering, by the computer, a first alert based on the predicted first confidence score.

2. The computer-implemented method of claim 1, wherein the first trademark term is associated with a first entity, and wherein the at least one cybersquatting event corresponds to a registration of one or more domain names associated with the first trademark term by a second entity different from the first entity.

3. The computer-implemented method of claim 2, further comprising:
retrieving, by the computer, first registration information associated with a registration of the first trademark term by the first entity, wherein the first registration information is retrieved from a first set of databases;
retrieving, by the computer, second registration information associated with the registration of the one or more domain names by the second entity; and
rendering, by the computer, a second alert based on a comparison of the retrieved first registration information with the retrieved second registration information.

4. The computer-implemented method of claim 3, further comprising:
receiving, by the computer, a second input associated with a transmission of a legal notice to one or more electronic devices, wherein the second input is received based on the rendered second alert; and
transmitting, by the computer, the legal notice to the one or more electronic devices based on the received second input, wherein the legal notice corresponds to a cease-and-desist notice.

5. The computer-implemented method of claim 4, further comprising:
generating, by the computer, the legal notice based on application of a second machine learning (ML) model on the retrieved first registration information, the retrieved second registration information, and the received second input; and
transmitting, by the computer, the generated legal notice to the one or more electronic devices.

6. The computer-implemented method of claim 4, further comprising:
generating, by the computer, a second set of databases with a set of cybersquatting events based on at least one of the first trademark term, the first set of features, the first registration information, the second registration information, and the first confidence score, wherein the second registration information is retrieved from a third set of databases; and
predicting, by the computer, a second confidence score associated with at least one cybersquatting event associated with a second trademark term based on the generated second set of databases.

7. The computer-implemented method of claim 1, wherein the first set of features comprises at least one of a length of the first trademark term, or classification information associated with the first trademark term.

8. The computer-implemented method of claim 1, further comprising:
determining, by the computer, one or more domain names associated with the first trademark term based on application of natural language processing on the first trademark term; and
predicting, by the computer, the first confidence score indicative of the at least one cybersquatting event associated with the first trademark term based on the determined one or more domain names, wherein the at least one cybersquatting event corresponds to a registration of the one or more domain names.

9. The computer-implemented method of claim 1, further comprising:
generating, by the computer, a training dataset comprising historical trademark term data associated with a set of historical trademark terms and historical event data associated with one or more cybersquatting events associated with each historical trademark term of the set of historical trademark terms; and
training, by the computer, the first ML model based on the generated training dataset.

10. The computer-implemented method of claim 9, further comprising:
calculating, by the computer, a first interval associated with registration of one or more domain names based on a first timestamp associated with a registration of the first trademark term and a second timestamp associated with the at least one cybersquatting event; and
training, by the computer, the first ML model based on the calculated first interval, wherein a second confidence score associated with at least one cybersquatting event associated with a second trademark term is predicted based on the calculated first interval.

11. A system, comprising:
processor set configured to:
receive, from a first set of databases, first registration information associated with a registration of a first trademark term;
determine one or more domain names associated with the first trademark term based on the received first registration information;
predict, by a first machine learning (ML) model, a first confidence score indicative of at least one cybersquatting event associated with the first trademark term based on the determined one or more domain names, wherein the first ML model is pre-trained on a training dataset stored in a second set of databases associated with a set of cybersquatting events; and
render a first alert based on the first confidence score.

12. The system of claim 11, wherein the training dataset comprises historical trademark term data associated with a set of historical trademark terms and historical event data associated with one or more cybersquatting events associated with each historical trademark term of the set of historical trademark terms.

13. The system of claim 11, wherein the first trademark term is associated with a first entity, and wherein the at least one cybersquatting event corresponds to a registration of the one or more domain names associated with the first trademark term by a second entity different from the first entity.

14. The system of claim 13, wherein the processor set is further configured to:
monitor a third set of databases for a first event associated with the registration of the one or more domain names, wherein the third set of databases is associated with one or more domain name registrars;
retrieve second registration information associated with the registration of the one or more domain names based on a detection of the first event; and
render a second alert based on a comparison of the received first registration information and the retrieved second registration information, wherein the second alert is indicative of registration of the one or more domain names by the second entity.

15. The system of claim 14, wherein the processor set is further configured to:
receive an input associated with a transmission of a legal notice to one or more electronic devices based on the rendered second alert; and
transmit the legal notice to the one or more electronic devices based on the received input, wherein the legal notice corresponds to a cease-and-desist notice.

16. The system of claim 15, wherein the processor set is further configured to:
generate the legal notice based on application of a second machine learning (ML) model on the received first registration information, the retrieved second registration information, and the received input; and
transmit the generated legal notice to the one or more electronic devices.

17. The system of claim 14, wherein the processor set is further configured to:
determine a first set of features associated with the first trademark term based on the received first registration information; and
train the first ML model based on the determined first set of features, the received first registration information, and the retrieved second registration information.

18. The system of claim 17, wherein the first set of features comprises at least one of a length of the first trademark term, or classification information associated with the first trademark term.

19. The system of claim 11, wherein the processor set is further configured to:
calculate a first interval associated with registration of the one or more domain names based on a first timestamp associated with the registration of the first trademark term and a second timestamp associated with the at least one cybersquatting event; and
train the first ML model based on the calculated first interval.

20. A computer program product for prediction of at least one cybersquatting event associated with a first trademark term, the computer program product comprising a computer-readable storage medium having program instructions embodied therewith, the program instructions executable by a system to cause the system to, comprising:
processor set configured to:
receive a first input associated with the first trademark term from a first electronic device, wherein the first trademark term is registered by a first entity;
determine a first set of features associated with the first trademark term based on the received first input;
predict a first confidence score indicative of at least one cybersquatting event associated with the first trademark term based on application of a first machine learning (ML) model on the determined first set of features, wherein the first ML model is trained on a training dataset comprising historical trademark term data associated with a set of historical trademark terms and historical event data associated with one or more cybersquatting events associated with each historical trademark term of the set of historical trademark terms; and
render a first alert on the first electronic device associated with the first entity.
